(19) United States
(12) Patent Application Publication
(10) Pub. No.: US 2024/0425097 A1
(43) Pub. Date: Dec. 26, 2024

(54) MULTIFUNCTIONAL TRANSPORT

(71) Applicant: Jeffrey Roy King, Kremmling, CO (US)

(72) Inventor: Jeffrey Roy King, Kremmling, CO (US)

(21) Appl. No.: 18/747,636

(22) Filed: Jun. 19, 2024

Related U.S. Application Data
(60) Provisional application No. 63/521,949, filed on Jun. 20, 2023.

(51) Int. Cl. B62B 15/00; B62B 17/06

(52) U.S. Cl. CPC B62B 15/007; B62B 15/002; B62B 15/004; B62B 17/06

(57) ABSTRACT

A multifunction transport is designed to provide transport over snow, ice, grass, or ground which being towed or pushed. The transport may also function as a shelter or chair when raised on end. The transport may be equipped with kits or inserts to facilitate different uses. The transport may include a harness which may be used with the transport or may be used as a trailer without the transport.

### CROSS-REFERNCE TO RELATED APPLICATIONS

This applications claims priority to provisional applications No. 63/521,949 filed on 20 Jun. 2023 the content of which is incorporated herein by reference.

### BACKGROUND OF THE INVENTION

Outdoor recreation sometimes involves traveling long distances to a particular destination. For example, hikers, kayakers, hunters, and anglers often travel to specific, remote destinations. These destinations are often not accessible by motorized vehicle. Therefore, the recreationist will carry his gear on his person, for example in a backpack or in his kayak. Where the destination traverses snow or ice, he may use a sled or sleigh to carry gear and supplies.

Ice fishing in one sport where anglers frequently use sleds to transport gear and supplies. Another is hiking over glaciated terrain. In either of these activities, the recreationists have protracted stays at the destination, often camping in remote areas far from lodging facilities. These activities often involve transporting a significant amount or a substantial weight of gear and supplies. Recreationist, therefore, seek out solutions for transportation of their gear and supplies. Maximizing the access to adequate and desired supplies, as well as tools and gear, is one goal in such endeavors. Another, but opposing, goal is to reduce the size and especially the weight of the load to be transported.

Balancing these factors has long been a challenge. A need exists to provide a transport, such as a sled or kayak that is multifunctional thereby eliminating the need for certain other gear. Moreover, a need exists for durable, light-weight transports which are designed to travel efficiently over the desired terrain while providing the maximum possible functionality for the recreationist.

The present disclosure provides an efficient, fast, easy, and cost effective transport which may have multiple transport modalities and may be adapted for different uses. For example, it may be used as a shelter or for storage. The present disclosure also describes the method of using the transport and describes alternative uses for different aspects of the transport. Moreover, it describes how to assemble and operate the transport.

### BRIEF DESCRIPTION OF THE DRAWINGS

FIG. 1A is a transport according to one embodiment.

FIG. 1B is a transport according to another embodiment which includes wheels.

FIG. 2 is a top view of a transport according to an embodiment.

FIG. 3 is a side view of an alternative embodiment of a transport.

FIG. 4 is a top view of yet another alternative embodiment.

FIG. 5 is a partial top perspective of yet another alternative embodiment.

FIG. 6 is a side view of another alternative embodiment of the transport without skis.

FIG. 7 is the front view of the transport shown in FIG. 6.

FIG. 8 is a side view of yet another alternative embodiment of the transport.

FIG. 9 is the front view of the transport shown in FIG. 8.

FIG. 10 is side view of an embodiment raised on end.

FIG. 11 is a side view of another embodiment raised on end.

FIG. 12 is a plan view of one embodiment of a harness.

FIG. 13A is an illustration of one embodiment of the transport with a ball type coupler for coupling to a vehicle.

FIG. 13B is an illustration of an embodiment of the transport with a U-shaped coupler for coupling to a vehicle.

FIG. 14 is an illustration of the embodiment of FIG. 13A being raised on end.

FIG. 15 is a view from the rear of yet another embodiment showing a sharp configuration for the bow rib.

FIG. 16 is an illustration of one embodiment of a ski.

FIG. 17A is an illustration of the block with the transport being horizontal.

FIG. 17B is an illustration of the block with the transport rotated on end.

FIG. 18A is a side view of an alternative design of a transport.

FIG. 18B close-up cutaway section of the rear portion of the transport of FIG. 18A.

FIG. 19 is a side view of an alternative design for a transport.

FIG. 20 is a front view of yet another alternative design for a transport.

FIG. 21 is a rear view of yet another alternative design for a transport.

FIG. 22 is a top view of yet another alternative design for a transport.

FIG. 23 is a rear view of yet another alternative design for a transport.

FIG. 24 is a front view of yet another alternative design for a transport.

FIG. 25 is a bottom view of yet another alternative design for a transport.

FIG. 26 is a bottom view of yet another alternative design for a transport.

FIG. 27 is a top view of yet another alternative design for a transport.

FIG. 28 is a front view of yet another alternative design for a transport.

FIG. 29 is a side view of yet another alternative design for a transport.

FIG. 30 is an illustration of an alternative design for a harness.

FIG. 31 is an illustration of an embodiment of a transport with a mating hood.

FIG. 32 is a front view of a transport with a hood having a generally flat top.

FIG. 33 is an exploded view of an embodiment of the transport with a hood.

FIG. 34 is an illustration of an alternative embodiment of a hood with a rail system.

FIG. 35 is an illustration of a hood and transport which are coupled using a rail system.

FIG. 36A depicts one embodiment of the body of the transport from the inside.

FIG. 36B depicts the embodiment of FIG. 36A from the outside.

FIG. 36C depicts the embodiment of FIG. 36A from the top.

FIG. 36D depicts the embodiment of FIG. 36A from one side.

FIG. 37 depicts one embodiment of a harness created with metal stock.

FIG. 38A depicts an alternative embodiment of a harness in partially exploded view.

FIG. 38B depicts the embodiment of FIG. 38A with the wheels assembled and raised.

FIG. 39A illustrates one embodiment of an exterior portion of hardware used in conjunction with coupling the harness to the body.

FIG. 39B illustrates an interior portion of the hardware depicted in FIG. 39A.

FIG. 40 illustrates one embodiment of a pin.

FIG. 41A is a perspective view of an embodiment of a hood cover.

FIG. 41B is the inside surface of the hood cover of FIG. 41A.

FIG. 42A is a side view a transport body with its hood cover.

FIG. 42B is a front view of the transport body of FIG. 42A.

FIG. 42C is a rear view of the transport body of FIG. 42A.

FIG. 43 is a perspective view of the transport of FIG. 42A with a hood cover and harness.

FIG. 44 is a perspective view of the body including a harness.

FIG. 45 is a perspective view of a handle.

### DETAILED DESCRIPTION

In the following detailed description, numerous specific details are set forth by way of examples in order to provide a thorough understanding of the relevant teachings of this disclosure. It should be noted, however, that the present teachings may be practiced without such details. In other instances, methods, procedures, and components have been described at a relatively high level. In those instances, the disclosure provides sufficient detail to describe and enable it to a person of ordinary skill, but avoids providing so much detail as to obscure aspects of the invention.

Sleds or sleighs are not limited to transport over snow or ice but may also be used in numerous other types of terrain. Sleds may be used over sand, hard earth, or even grass. Moreover, even though this disclosure is narrated mostly with respect to an ice fishing sled, it is not limited as such. Any hunter, angler, hiker, backpacker, outdoor enthusiast, other athlete who has occasion to transport gear or supplies using a sled transport system may benefit from the teachings herein, and a variety of transports may be constructed consistent with the features disclosed herein.

Moreover, sleds may include different mobility modalities which depend on the terrain. Some include a smooth bottom which is designed to slide or glide. Some may include ribs or projections on the bottom. Others may include the projections on the sides to be used as skis. Others may include skis or runners. Yet others may have skates or skids. These transports may travel over snow, grass, ice, sand, or ground. The skis or skids may be formed contiguous with the body of the sled or mounted thereon. Some sleds may include wheels similar to a wagon, for example for travel over hard or uneven ground. Kayaks may be adapted with these same features so they may be used as land transport or portaged easily.

The transports disclosed here may be made lightweight or heavy depending on the particular end use. They may be fabricated from a range of different materials, including those used to construct sleds and kayaks. Some materials include plastics, polymers, metals, wood, and composites. High molecular weight polymers such as UHMW, UHMWPE, HMWPE, and IPX UHMW, IPX UHMWPE, with or without fiber reinforcements, are also contemplated for the construction of the transports. Additionally, acetal polyoxymethylene resins including Delron or Delrin® may also be used. Moreover, natural materials, or fibers derived from natural materials, may be used for the construction of the transport or in composites used to construct the transport. One specific example is hemp, which may be used to construct the panels, skis, and the different parts of the transport or it may be used in a composite, for example similar to fiberglass. Use of hemp or other biodegradable material is more environmentally friendly.

The transports may be one-piece unitary structure, a monolithic structure, or made from multiple sections joined together. The transports may be coated or painted for weather resistance, to reduce friction, improve aerodynamics, for strengths, or for ornamental purposes. They may be designed in large or small sizes with a variety of proportions. They may be equipped with additional features to suit a particular need. These features are generally dictated by the particular end use.

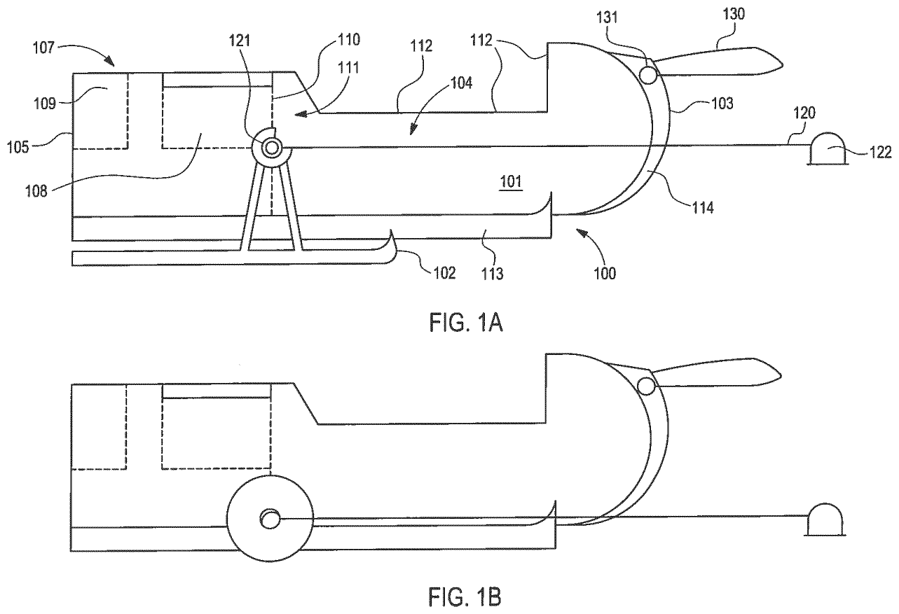

Figure (FIG. 1A shows an embodiment of a transport, in this embodiment a sled, 100 (or other transport as noted above) including a body 101 and runners or skis 102. The skis may be replaced with skates, skids, ribs, wheels, or be eliminated, consistent with the terrain of travel. The sled body 101 may be made into a variety of shapes, some of which are disclosed in the present embodiments. The shape of the body, however, is generally selected to achieve the following: facilitate travel by minimizing friction and air resistance; maximizing load-balancing for stability and reduction of undesirable inertia; ease of maneuverability; degree of enclosure; and adaptations to multifunctional uses or kits as described below. With respect to water vessels, buoyancy, stability, and other nautical considerations are generally relevant. In one embodiment, the size of the body may be manufactured to be about 77 inches long.

In the embodiment of FIG. 1A, the body 101 is selected with a curvilinear front portion or bow 103, a flat rear 105, and sides 104 on the left and right. In some embodiments, the bow resembles that of a canoe. Alternatively, it may be formed in the shape of a kayak bow.

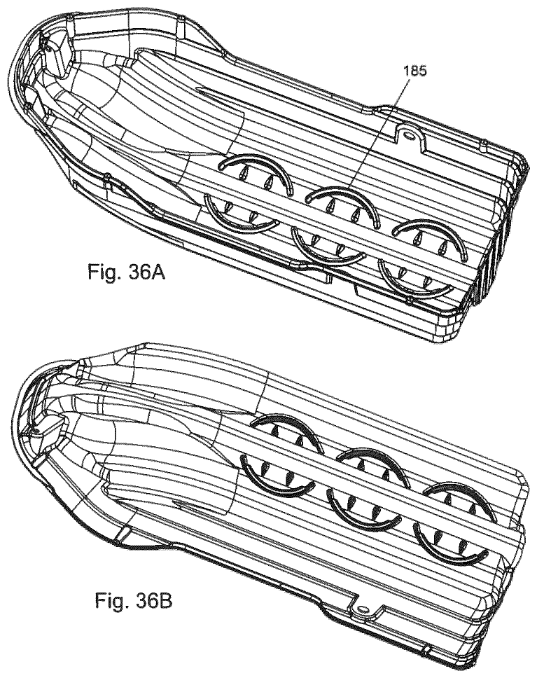

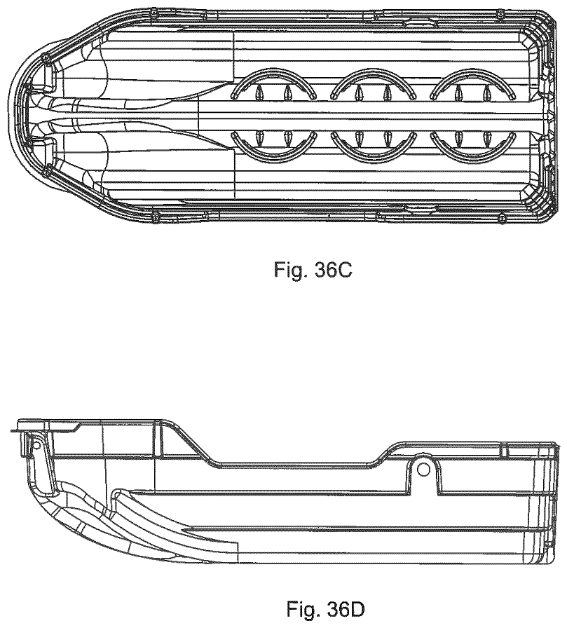

Alternatively, it may be flat. In one embodiment, the height of the front portion may be manufactured to be about 19 inches. Various portions, including the skis or the bow, may be formed as ribs in or on the body 101. Ribs 113 and 114 are examples of such formations. Other examples can be seen in other figures including integral ribs formed in the embodiment of FIGS. 36A-B. Ribs 113 may be in addition to or in lieu of skis 102. They may be formed of the same or different material than the body. They may be formed integrally, contiguously, or coupled thereto. Rib 113 may also be screwed or riveted onto the body 101. The ribs 113 may be formed as a ski for added maneuverability.

In one embodiment, the body may be manufactured with three ribs, functioning as skis: one in the middle extending from the bottom of Rib 114 and extending to the rear of the body. The other two being located one on either side, extending from about half way on the bow along the bottom to the rear of the body. FIGS. 36A and 36B illustrate the bottom contour of the body with the three ribs from the inside and the outside, respectively.

Rib 114 may be formed with a blunt edge to act as a ram and absorb force or provide impact. Alternatively it may be formed with a curved leading edge or a pointed edge (e.g. FIG. 15) to facilitate cutting through the snow and enhance maneuverability. Ribs generally also increase the structural integrity of the body.

FIG. 1B is an alternative embodiment with a wheel instead of a ski. This embodiment may or may not incorporate the ribs 113.

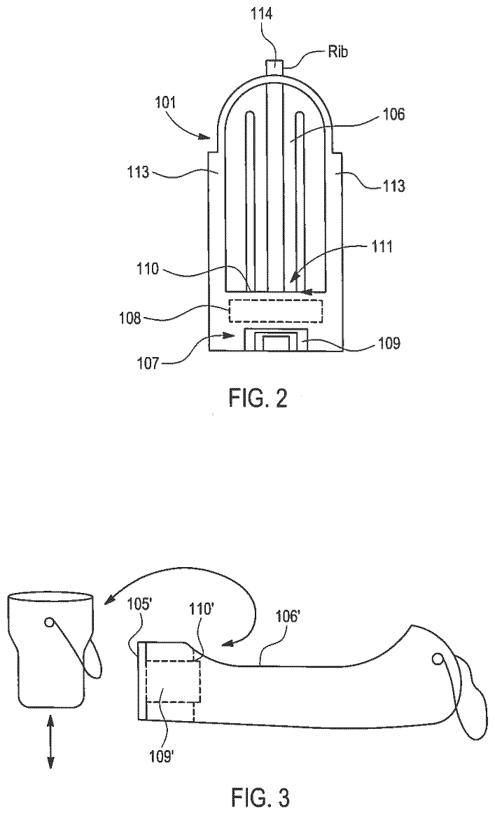

FIG. 2 is a top view of body 101. With reference to FIGS. 1-2, passengers, gear, and supplies are placed inside the sled 100. Open section 106 is a general area for passengers and supplies. This portion may include floor projections or features to enhance structural strength—for example by including stiffening ribs. It may also include features to assist in securing cargo, for example as described below with respect to contours 185. Projections or features may also be used to make the floor of section 106 less slippery. Cross braces may be formed to enhance the structural integrity.

The interior portion adjacent rear 105 includes storage portion 107. Storage portion 107 may include a covered compartment 108 for supplies and gear. The cover may be a lid which may be attached in desired manner, including hinged, sliding, complete removable, etc. The storage portion may be substantially as large as portion 107, or it may only include a portion thereof. FIG. 1A shows storage 108 which constitutes only a section of portion 107. In the embodiment of FIG. 1A, portion 107 includes an additional receptacle 109, which is an area for storing additional equipment.

Portion 107 includes a wall 110 which faces the section 106. This wall provides a natural backstop for compartment 106 (FIG. 2). It additionally provides one side of storage portion 107. It additionally provides the frame for any surface, seat, lid, or other structure which may be placed or mounted thereto. Wall 110 may function as a cross brace to enhance the structural integrity of body 101.

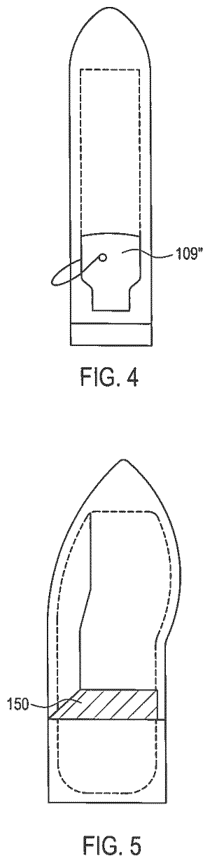

In the example of FIG. 1A, receptacle 109 is adapted for storage. In some embodiments, the receptacle is specifically adapted to receive a five-gallon bucket. The bucket may be vertically slid into the opening at 109. The contour of the opening may be adapted to the shape of the bucket. Alternatively, it need not be. Alternatively, the receptacle may be oriented in a different direction. For example, as shown in FIGS. 3, receptacle 109′ is configured to receive the bucket horizontally from the inside through wall 110′. In the example of FIG. 4, the receptacle is formed so that it is accessible from the top. If a bucket is used, it may be placed in it horizontally. Receptacle 109 may be open or covered.

In the embodiments of FIGS. 3-4, if a bucket is used, it may be placed with its bottom facing the section 106′ (FIG. 3 at 109′) or the end 105′ (FIG. 4 at 109″). The opening to receptacles 109′ and 109″ may be in the wall 110′ or in the rear 105′. It may be covered or left open. Moreover, where the opening is facing open section 106′, it may be formed in wall 110′, or wall 110′ may be removable and the opening formed behind it. That is, wall 110′ may fold down or slide up to expose receptacle 109′.

FIG. 5 shows an alternative embodiment where the wall is solid. The storage portion and receptacle may be formed behind the wall but are not specifically depicted in FIG. 5. In all configurations, receptacle 109 may be equipped with one or more clips or tethers to secure the bucket in place. Area 109 can be adapted for storage of other containers, built-in or standard; or it may be eliminated altogether.

In the embodiment depicted in FIGS. 36A-D, the storage area is eliminated altogether and instead contoured areas are formed in the floor (185 in FIG. 36A) to hold removable storage containers, for example a standard 5-gallon bucket. In this embodiment, by eliminating the built-in storage structures, the available volume inside the body is increased.

Transport or sled 100 may additionally include a lift bar, tether, or harness 120 (FIG. 1A). Tether 120 is secured to the body 101 at attachment 121. On the distal end, tether 120 includes hardware 122. In the embodiment of FIG. 1A, the hardware is a tow ball, which may be coupled to a tow hitch on a vehicle-for example a snowmobile or a 4-wheeler. Other embodiments of couplers are illustrated in FIG. 13B, 35, 37, 38. Tether 120 and its hardware may be used to tow, pull, or secure sled 100 horizontally or vertically. The hardware 122 may be adapted to couple with other hardware to complete a tow mechanism. It may couple with a harness to assist in pulling the sled. It may be used as a guy line and be secured to the ice or to an anchor.

Tether 120 may be flexible or rigid. For example, it may be composed of a rope or wire. Alternatively, it may be a bar or a harness made of metal or plastic. It may be solid or hollow. It may be adjustable in length or telescoping for ease of storage. While not shown in FIG. 1A, body 101 may include features to hold or stow tether 120 on the side of the body 101 or elsewhere on in the transport.

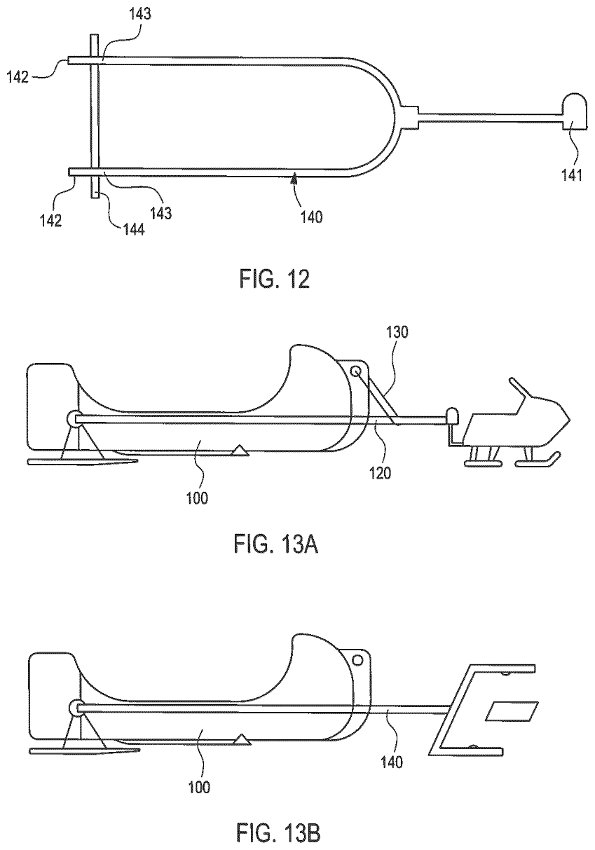

Tether 120 is fixed on the body 101 at attachment 121. In the embodiment illustrated in FIG. 12, the tether is a harness, shown at 140. The harness 140 has the coupling end 141 to which the tow ball or tow gear may be coupled. The distal ends 142 are coupled to body 101 (FIG. 1A). Each end 142 may include an opening 143 which couples to a dowel or cross bar 144 which may pass through the opening 143, then through an opening at 121 in the body 101, then traverse behind wall 110 (FIG. 1A). When so assembled, cross bar 144 may act as the hinge for a lid to compartment 108. After exiting through the hole at 121 on the other side of body 101, cross bar 144 passes through the opening 143 on the other side of the harness.

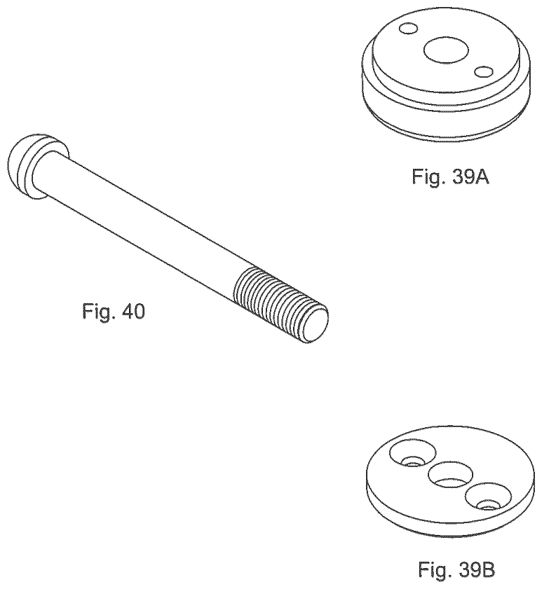

Openings 121 may be outfitted with hardware for durability and ease of use. Using hardware, for example metal discs are shown in FIGS. 39A-B, act as shock absorbers or strain relief with respect to the opening in the body and prevent premature damage to the body. In the embodiment of the FIGS. 39A-B, a pair of metal discs are shown which may be installed in the opening (121 in FIG. 1). The disc shown in FIG. 39A is placed in the opening from the outside of the body. The metal disc in FIG. 39B is coupled with it from the inside of the body. And the two discs are secured to each other with hardware, including screws or rivets, through the two outside holes. The center hole in the discs will receive the cross bar or attachment pins. One embodiment of attachment pins which may be used in the center hole of the discs for attachment of wheels or skis is shown in FIG. 40. The pins are configured to permit secure attachment while being removable and able to accommodate different transport modalities.

The ends of cross bar 144 may be fitted with hardware to keep it in place. In one simple, inexpensive, and removable configuration, the ends of 144 include openings to accommodate cotter pins for securement (not shown). Other hardware may also be used. Moreover, the ends of crossbar 144 maybe include enlarged portions which are screwed onto the bar. The enlarged portions are screwed off to allow the crossbar to be removed and screwed on to secure it in place (not shown). In applications where the crossbar 144 need not be removable, it may be fused with the harness or permanently coupled thereto. Alternatively, it can be permanently connected to or embedded in body 101.

FIGS. 12 and 30 show two examples of designs for a harness. Harnesses may provide added structural integrity by acting as a cross brace across the width of body 101. The harness 140 as shown in FIG. 12, includes a frame 142 and cross bar 144. Cross bar 144 of the harness may be coupled at each end to the portions 121 where the skis or wheels attach to the transport body. This improves the rigidity of the transport. Whether designed as a harness or a frame, rope, or bar, the harness may add structural support by functioning as an external frame. Moreover, it may operate as the pulling or towing mechanism. It may also be rotated rearward to be used as a harness or a stabilizer in the rigging used to push the transport.

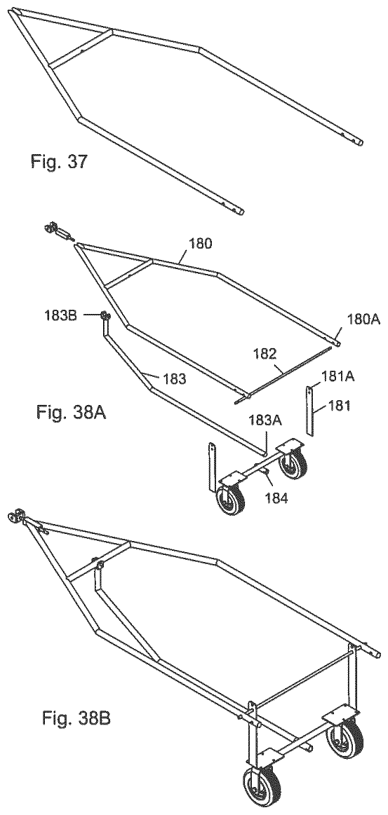

FIG. 37 depicts one embodiment of a harness created with round metal stock. Naturally, stock with other cross sections, including rectangular tubes, may be used to create the harness. In this embodiment, the rounded top of the harness as shown in FIG. 12 is replaced by a triangular shape which includes a horizontal member connecting the right and left sides of the harness. If the harness of FIG. 37 is used in combination with the transport of FIG. 36A, it may be coupled to the openings in the sides of the body and coupled thereto using a crossbar (e.g., 144 in FIG. 12) or using hardware, for example, the pins as depicted in FIG. 40.

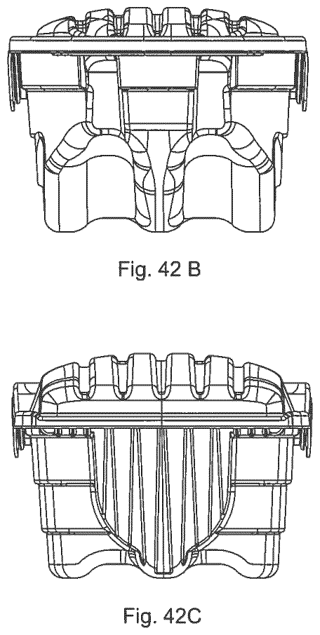

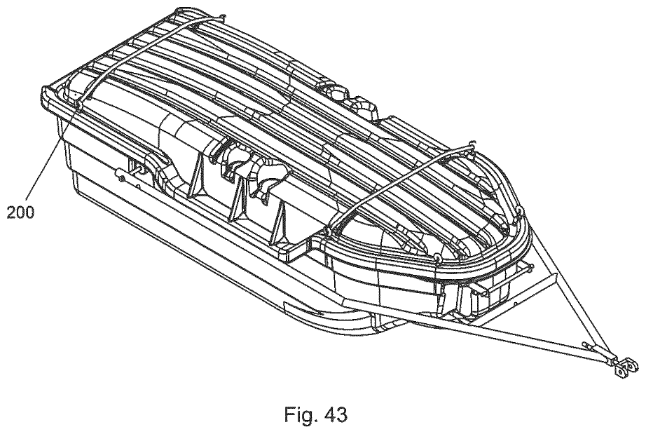

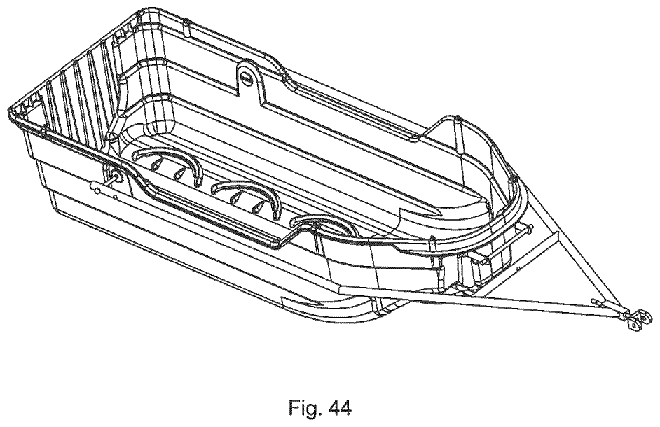

The lip on the bow of the transport (as visible in FIG. 42A) may be spaced from the horizontal member on the harness. Alternatively, it may butt up against it. Alternatively, it may rest on it. In FIG. 43, the edge of the lip on the bow butts up against the horizontal member. As can be seen in FIG. 43, the body is coupled to the harness using the rear-most hole on the harness. If instead the body were coupled to the harness using the forward-most hole, the lip would be resting on the horizontal member. A multiplicity of holes can be placed to allow various spacing between the body and the harness. With these holes, the connection of the harness to the body does not permit relative movement between the body and the harness, to and fro, and locks the position of the body on the harness. Therefore, to secure the body on the harness with the lip resting on the horizontal member, the appropriate hole would be used to couple the body to the harness. Alternatively, the holes may be formed as slots, as further described below with respect to FIG. 44.

The sides of the body may rest on the sides of the harness (as seen in FIG. 44A). The skis or wheels may extend from the body below the bottom and onto the ground, allowing the transport to be towed (not shown).

FIGS. 38A-B show an alternative embodiment of a harness. When this harness is used, the transport will be supported by the harness off of the ground. Motility is achieved by using the wheels on the harness and not the transport. In this and the embodiment of FIG. 37, the tip of the triangular portion of the harness may be outfitted with hardware for towing. A couple of common examples of tow gear include a tow ball (141 in FIG. 12) or a clevis connection (FIG. 13B).

The harness as depicted in FIGS. 38A-B, is shown partly exploded in FIG. 38A. The harness may be easily assembled and disassembled as follows: While the frame 180 is placed flat on the ground, the wheel base 181 is placed adjacent the end of frame 180 such that holes 181A on the wheel base 181 are adjacent slots 180A on the frame. Once the holes are lined up, connecting pins are inserted to secure the parts together. Instead of connecting pins, a cross rod 182 may be used.

Once the frame and the wheel base are coupled, the end of the frame adjacent the wheel base may be lifted while the triangular end of the frame remains on the ground. The slots 180A allow the pin or cross bar to freely rotate allowing the coupling permitting the wheel base end of the frame to lift off of the ground, FIG. 38B. In this position, end 183A of center bar 183 may be forced into coupler 184 which is fastened to the wheel base. In the embodiment of FIG. 38A, the coupler 184 is welded to the wheel base. Alternatively, it may be connected securely with hardware or fabricated integrally with it. End 183A is a friction or forced fit within coupler 184. But, other known connection types may also be used. Once end 183A is connected, end 183B is coupled to horizontal member 184. In the embodiment of FIG. 38A, end 183B is coupled to member 184 with a u-shaped coupler and pin as demonstrated. Alternatively, other coupling mechanism may be used. Note that this configuration of the harness additionally provides for a stand-alone trailer which may be used to tow other loads independently from its use with the transport.

The harnesses disclosed herein may be coupled to a vehicle in a variety of ways. FIGS. 13A and 13B illustrate two examples of couplers which may be used to couple the transport or the harness to a vehicle. FIG. 13A is a ball-type coupler and FIG. 13B is a U-type coupler. In a simple version, the U-coupler attaches to the tow attachment with a through pin or a pair of cotter pins. One example is shown in FIG. 35 another in FIG. 38B.

Referring back to FIG. 1A, when tether 120 used in conjunction with rope 130, a two-point attachment is created for coupling to a towing vehicle. Such a configuration is very stable and maneuverable. Referring to FIG. 13A, rope 130 is a bungie or elastic rope which limits the rotational freedom of the body without being a rigid connection. Rope 130 is wrapped around the tether 120 at the front of the transport, proving a second point of attachment, which permits some degree of movement. When the transport is being towed, as it moves over uneven terrain, the two-point attachment created by rope 130 and tether 120, keeps the transport stable and upright while still providing sufficient pivot so that it can swivel up and down over the terrain-effectively acting to mitigate shock to the body.

Moreover, if the body 101 is equipped with both an external ski, (102 in FIG. 1A) and ribs which functions as a built-in ski (113 shown in FIG. 1A), one or the other will likely remain in contact with the ground as the transport traverses up a bump or descends on its downhill side. The combination of the skis, ribs, tether, and rope create a more stable ride with less impact from bumpy and uneven terrain. Moreover, a combination of skis and ribs provides an effective balance between reduced friction on the ground and increase balance and control during travel. Even further, if the body includes a bow rib 114 (FIG. 2) which is sufficiently sharp to cut through snow; then, in operation, the sled will smoothly cut through snow drifts, rising on the skis and ribs while going over bumps and then making early contact with the snow on the downhill slope, riding down smoothly.

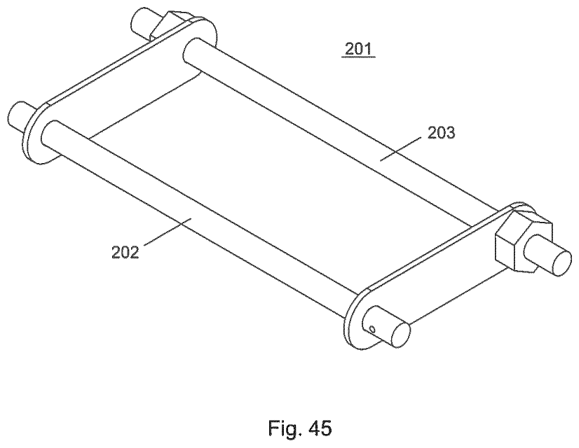

Referring again to FIG. 1A, transport 100 may include rope 130 and rope attachment 131. Rope 130 may be used in conjunction with or in lieu of tether 120. The rope 130 may be a coupled to the body using two holes in the rib 114, one on each side. In the embodiment of FIG. 1A, rope 130 is secured to the transport by routing it through holes 131 and securing it with a knot or cleat. Alternatively, rope 130 may be secured using hardware build into rope attachment 131. In conjunction with or in lieu of role 130, the bow may include a handle. One example of a handle is shown in FIG. 45. Handle 201 is a simple metal handle (even though other known configurations are also contemplated). Bar 202 of handle 201 passes through the bow openings 131. The remainder of the handle body rotates around bar 202 and will lie flat against the bow or rotate up to be held on grip 203.

The combination of rope 130 and attachment 131 is configured to provide a securement mechanism which is affixed to the forward half of transport 100 while tether 120 is attached to the rear half, as depicted in FIG. 1A. While it may be placed in line with tether 120, if this securement mechanism is spaced higher from the attachment point of tether 120, as shown in FIG. 1A, it provides an alternative angle of tow which may be more stable. Moreover, it provides an alternative point of attachment, spaced from attachment 121, when the rope 130 and tether 120 are used as guy lines or used to secure the sled in an upright position. Rope 130 may be made from a variety of flexible or inflexible constructions and it may include hardware.

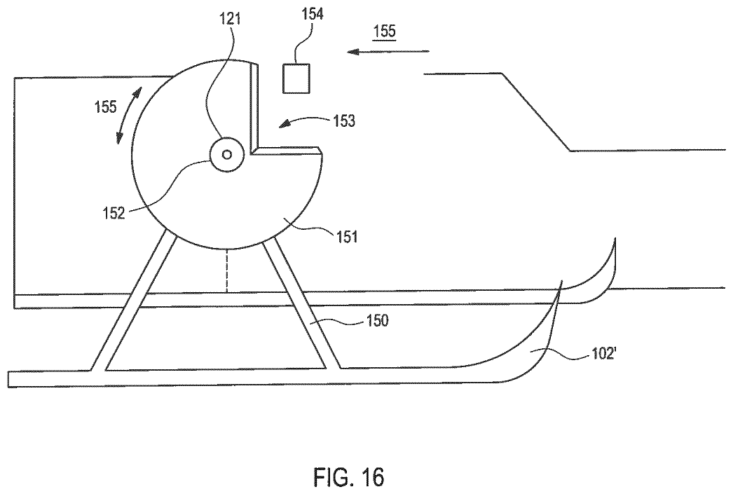

As discussed above with respect to FIG. 1A, the body 101 may be equipped with ribs 113 which may be shaped and sized to function as skis or runners. In the particular example of FIG. 1A, the transport also includes external skis 102. External skis may be connected to the body using a coupling mechanism as shown in FIG. 16. Skis 102′ are coupled to frame 150 by coupling portion 151. Coupling portion 151 rotatingly couples to attachment 121 of body 101 (FIG. 1A) at center portion 152. The coupling portion 151 allows the body to rotate around the skis (or wheels) to be raised. In FIG. 16, the center portion 152 comprises a hole through which a crossbar or dowel (for example cross bar 144) can be inserted to secure the skis 102′ to the body of the transport while still allowing the transport to be raised on end. Alternatively, other couplings may be used including ball joints or bearings or other hardware to create a removable or permanent connection.

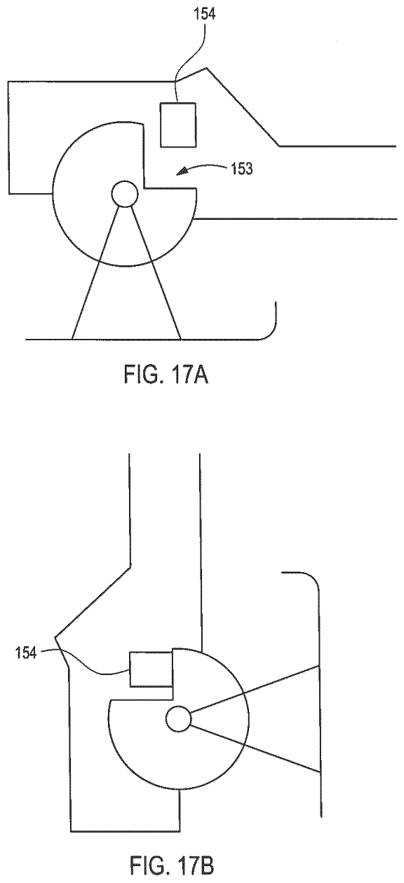

In the embodiment of FIG. 16, block 154 provides a back stop to prevent rotation of coupling 151. Block 154 is attached to the body of the transport within the area of the cutout portion 153 of coupling 151. When the transport is horizontal, for example as illustrated in FIG. 17A, block 154 prevents excessive rotation of coupling 151 is the directions of arrows 155 (FIG. 16). When the transport is rotated on end, for example as illustrated in FIG. 17B, block 154 provides a back stop to prevent further rotation of the skis. Instead of block 154, other locking or stopping mechanism may be used such as those built into a rotating joint, a retractable dowel, or a pin. Moreover, coupling 151 may be removably coupled to attachment 121. With a removable coupling 151, the skis may be removed or replaced with other modalities such as wheels, for example as shown in FIG. 1B.

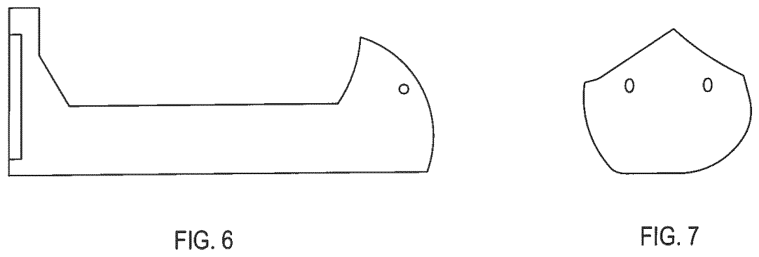

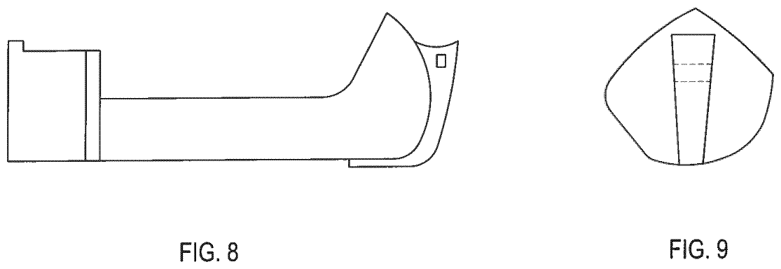

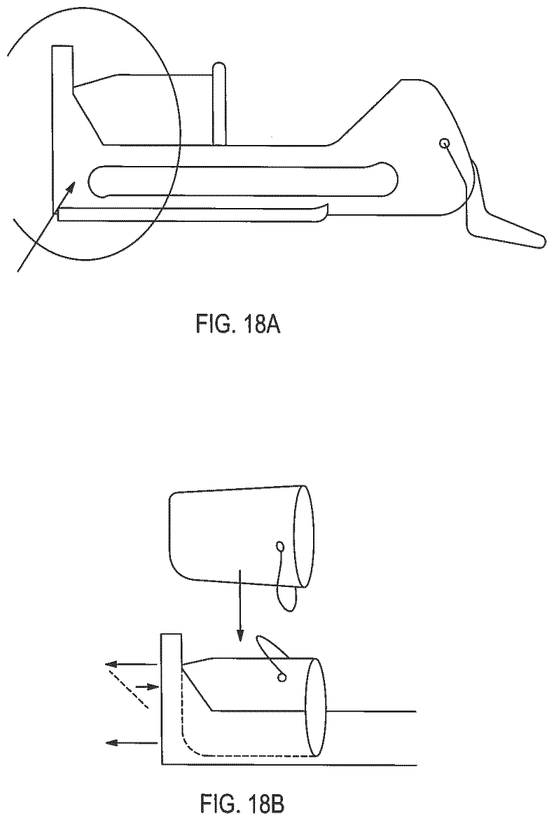

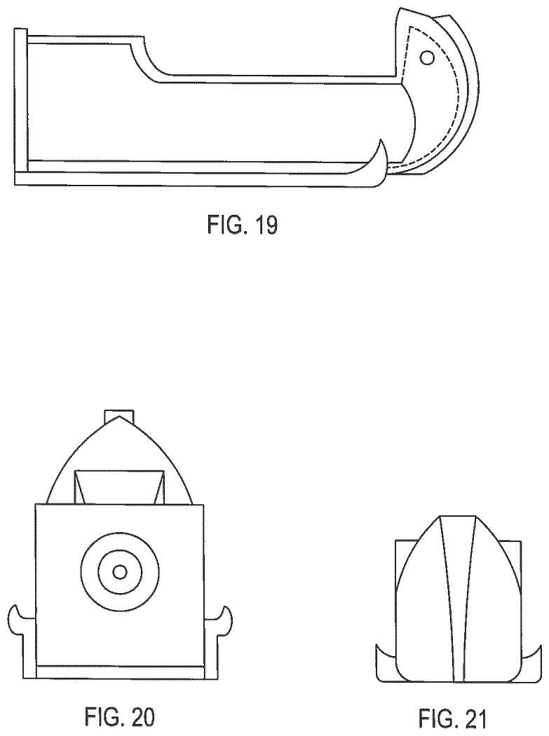

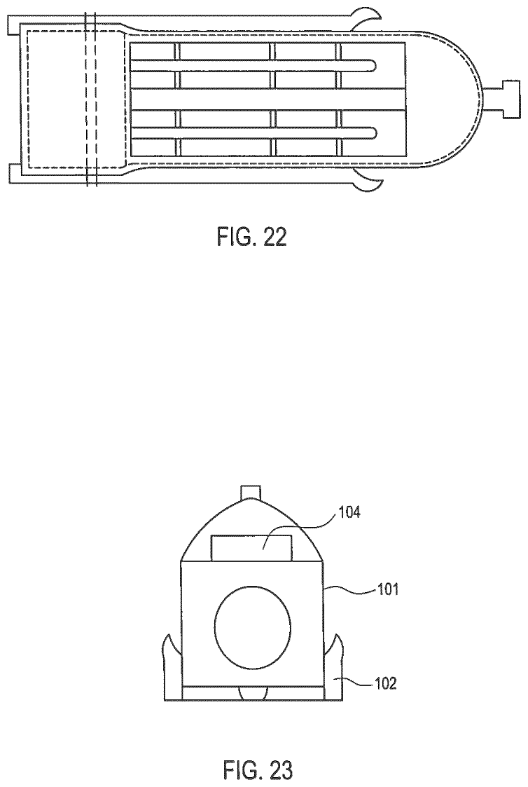

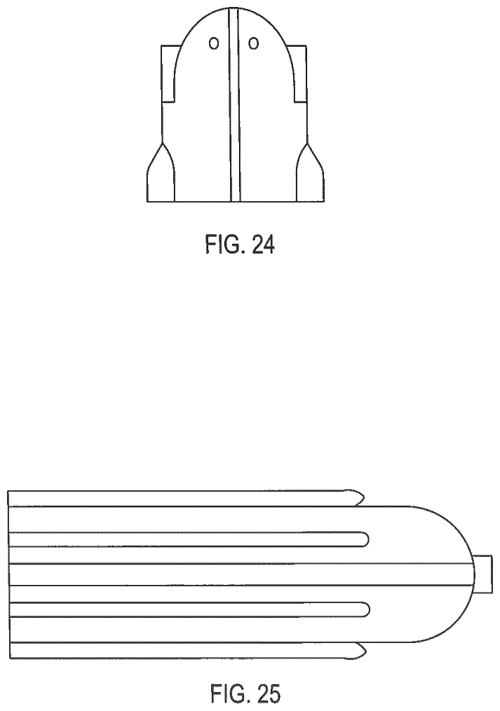

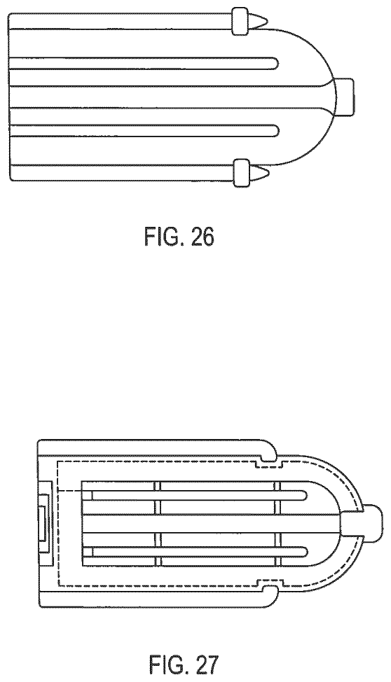

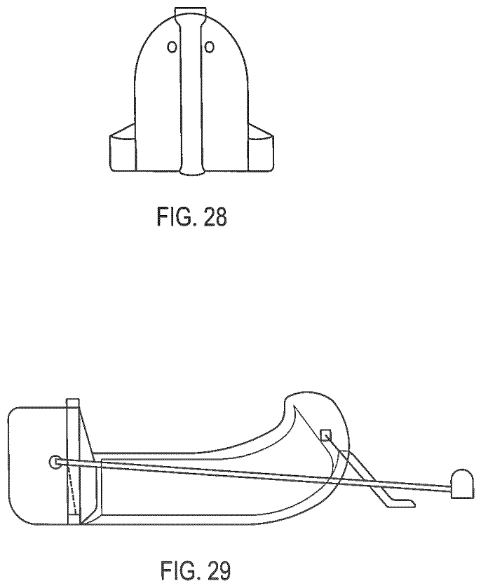

FIGS. 6-9, 15, 18A-35, 36A-D show top, side, rear, front, or bottom views of alternative embodiments showing different forms and shapes of the transport body, which optimize the transport with respect to one feature or another-or for aesthetic purposes. For example, the different configurations increase or decrease the storage portion and thereby decrease or increase the available open section 106. These alternative designs also demonstrate variations in the style and engineering of the body, ribs, and skis to achieve various benefits as noted herein.

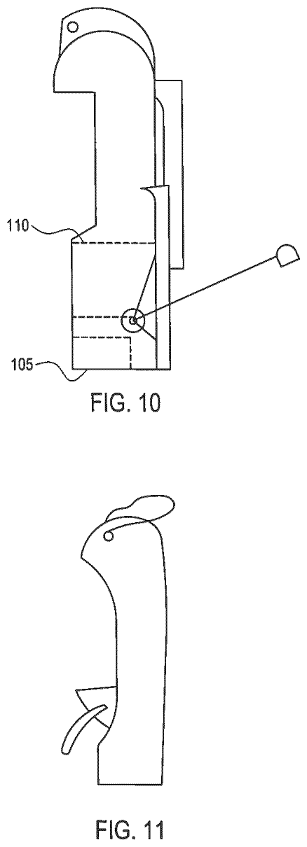

The transport of the present application may be designed to provide functionality as a chair, shelter, or other appliance. In one embodiment, the transport may be raised on end to form a shelter or chair. FIG. 10 shows a transport similar to the embodiment disclosed in FIG. 1A, raised on end to form a covered chair. The body may be configured in a manner permit it be raised on end. For example, it may be configured with a generally planar end portion. The raised transport then rests on end 105, which is configured with a width and surface as to be stable when balanced on end. Depending on the design of the skis (102 in FIG. 1A) or ribs (113 in FIG. 1A), the skis or ribs may provide additional support and stability for the transport raised on end, for example by increasing the surface area or the design of the footprint upon which the transport rests.

In the configurations of FIGS. 10-11, the transport is shown as being raised on its end. In FIG. 10, wall 110 functions as the seat. See also FIG. 5. In FIG. 11, a transport, similar to the embodiment of FIG. 3, is raised on end and a bucket is placed in the receptacle.

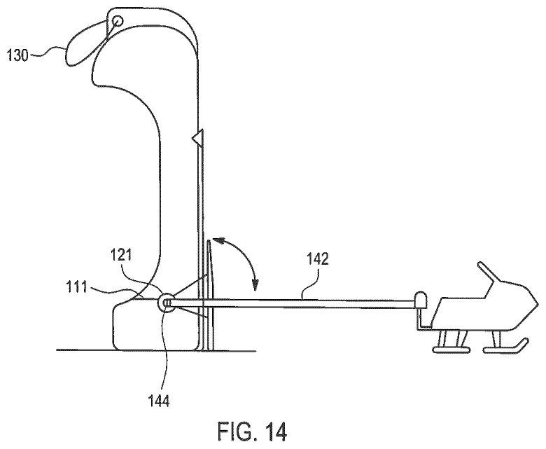

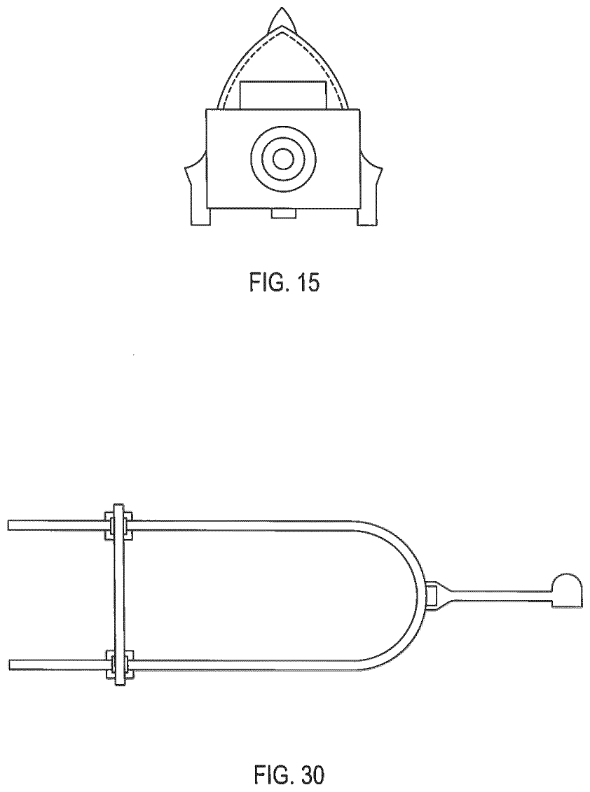

The transport may be raised on end by lifting it. When a tether or harness is used, it may assist in this function. FIG. 14 shows an embodiment where a harness similar to that shown in FIG. 12 is used. The transport may be in tow for example by a snowmobile. To raise the transport, the snowmobile is stopped but the hitch remains connected. The transport remains secured to the snowmobile. In this configuration, one person can easily lift the bow and raise the transport on end, as shown in FIG. 14. Rope 130 can be used to help the operator grab and raise the bow. As the bow is being elevated, the back end of the sled will not slide or slip because it is held in place by harness frame 142. The body of the transport will pivot at the attachment point 121 to allow the bow to lift and raise the transport on end. This easy-lift capability is advantageous for solo travelers which will have to raise the transport without help. Once in place, the skis may be adjusted to provide further stability to the upright structure. When using the harness as shown in FIG. 37 or 38B, the transport can be unloaded and erected by detaching it from the harness and sliding the end closest to the wheel base on to the ground and lifting the bow up. Note that by selecting an appropriate height for the harness, the transport and harness can be easily used by a recreationist in a wheel chair. Finally, either or both of harness frame 142 or rope 130 may be used as guy lines to secure the sled to the ground or to another structure.

When the transport is used as a chair or shelter, the floor of the section 106 functions as a backrest. The forward portion or bow (FIG. 1A) may overhang wall 110 and provide a roof or cover which protects from rain, snow, wind, or sun. Additionally, the sides 104 in combination with the bow form a partial enclosure around wall 110 forming a cavity which functions as the shelter. The degree of enclosure can be increased or decreased by the specific shape of body 101. The higher the sides 104 and the smaller the open top of section 106, the more enclosed the shelter. The lower the side 104 or larger the open top of section 106, the less enclosed. For example, the shelter created in FIG. 1A is more exposed and less enclosed than the one shown in FIG. 5.

Additionally, when the wall 110 is removable, the seat portion 150 (FIG. 5) may serve as the cover to the storage portion 107 (FIG. 1A). That is, the wall 110 may function as a hinged lid and lifted to expose the compartments below, for example compartment 108 or receptacle 109. If the lid is hinged, the hinge may be provided by crossbar 144 as shown in FIG. 14. That is, the crossbar not only functions to secure the harness to the sled body, but also provides the hinge for the lid.

If the lid is slidable, it may slide or pull out to reveal the compartments beneath it. If it is completely removable, it may be lifted to expose the compartments. Moreover, the underside of wall 110 may be adapted to create a seal with the receptacle beneath it (for example to insulate the receptacle). It may also be adapted on the top side 111 with a seat covering, such as for warmth or comfort. For example, the top side may be padded or it may include a heating element embedded in it. Alternatively, the inside of the compartment may include a heater.

The storage portion to the rear of wall 110 and top side 111 are multifunctional and may be put to many uses. Top side 111 may function as a seat or shelter. It may be equipped with receptacles or pockets for placement of chemical or battery-powered warmers such as off-the-shelf hand warmer packets. Top side 111 may also function as the seat to a portable commode. In this configuration, the commode portion will be configured into the receptacle 109″ similar to that shown in FIG. 4.

Alternatively, top side 111 may function as a cooking surface and may be supplemented with features to hold a stove or burner or have an area for food preparation. The storage compartment or receptacle beneath 111 may be configured accordingly. Alternatively, the compartment may be adapted to hold charcoal or other fuel for use as a grill. In this embodiment, the topside may include a grill grate. In this embodiment, the construction of the body and relevant parts must be made to safely withstand the expected heat.

In fact, both the storage portion 107, including compartments and receptacles 108 and 109, as well wall 110 may be fabricated with alternative configurations which are readily swapped out to provide various functionality. For example, the receptacle and top side 111 may be configured with a built-in burner and plumbing to attach to a fuel source within the receptacle.

The receptacle may include a refrigerated portion or a heated portion for storage. The top side may include a mini cutting board or sink. The interior configuration of the storage portion 107 or receptacles therein may constitute removable inserts. If the user, for example, prefers to adapt the shelter for cooking instead of for seating and storage, then he can remove the seat and storage that are configured into wall 110, top side 111, and underlying compartment and replace them with the “kitchen” insert and the corresponding wall/cover that are particularly designed for cooking.

Various inserts may be created for use with the adapted transport as disclosed herein. The inserts may be provided as kits including a wall/topside and an insert to be placed inside portion 107. The kits may be adapted for various uses and may be created or sold separately. They may cover any useful customization including a “bath kit”; a “portable commode kit”; a “kitchen kit”; a “fish cleaning kit”; a “gear and tackle kit,” “seat kit,” “bed kit”; a “charging station” with outlets and connectors for device charging, and the like. The gunnel of the sled, or the portion adjacent the rim 112, may be adapted with permanent or removable hardware to enhance the insert functions. For example, holes or fasteners may be placed along this location which will interface with a mating parts. That mating parts may provide clips for a water bag or tubes for use with the bath insert. Alternatively, they may provide for hanging hooks for the kitchen insert, or fasteners to secure a cover or door for the shelter. Solar panels or other equipment may be coupled to the sled. The mating parts may provide connections for lights or a toilet paper holder.

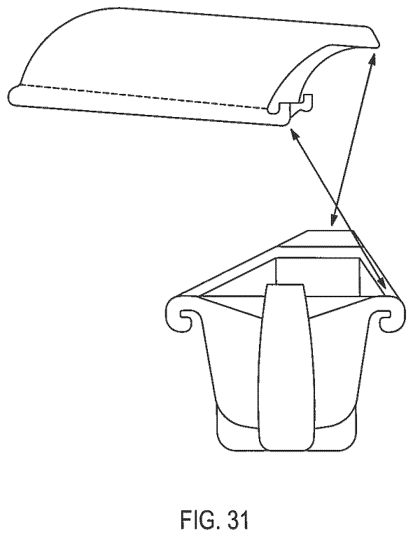

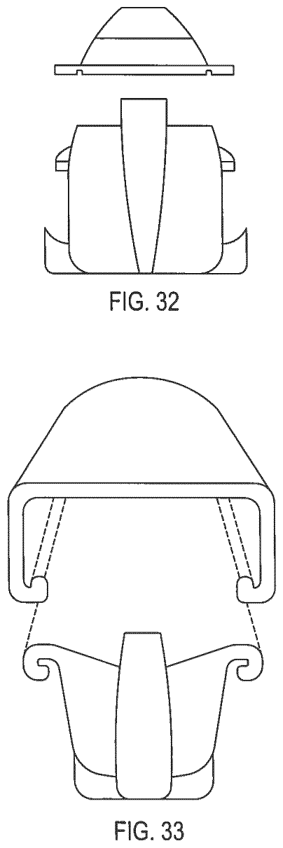

The transport of the present disclosure may be equipped with a hood which covers the opening of section 106. The hood may be configured to fit on the floor of section 106 when flipped upside down. When flipped back, it may be of the size and shape necessary to cover the opening. The hood may have different shapes including flat or domed or sharp. FIGS. 31-33 and 35 show some alternative shapes for the hood. The hood may be secured onto the body or on the gunnel using hardware. Alternatively, the body may be preconfigured with features which allow the cover to rest on top or snap into place. When traveling, the cover may be transported with the sled. In one embodiment, the hood may be stored on the floor inside the transport.

FIG. 31 illustrates a transport with a hood cover. In this embodiment, the hood cover mates with the body of the transport on its perimeter. In FIG. 31, the gunnel of the body has a surface with a curved shaped which acts as a female receptacle for the mating surface of the hood which constitutes a male ridge around the perimeter of the hood. Alternatively, the body may have a mating surface that is created below the gunnel on the outside of the body. The two mating surfaces come together and mate to secure the hood to the body. The mating surfaces may be configured with shapes that snaps together or with shapes that interlocks. The mating surfaces may be configured to allow the hood to be placed on top of the body and mated in place, for example by pushing down and snapping the surfaces together. The mating surfaces may also be configured with channels or grooves which allow the hood to slide onto the body from front to back or back to front. The mating surfaces as described in this paragraph are hardware free. But as noted earlier, the hood may be secured onto the body with hardware including latches.

Where the hood is shaped to overhang the mating surfaces, water and external elements will roll off the hood and past the body thereby preventing external elements from entering the covered body of the transport. FIG. 32 is a front view of another embodiment of the hood which rests in placed using mating surfaces at the perimeter of the hood and body. The hood has a generally flat top and overhands the body of the transport. FIG. 33 illustrates another embodiment showing an alternative shape for the hood and the mating surfaces.

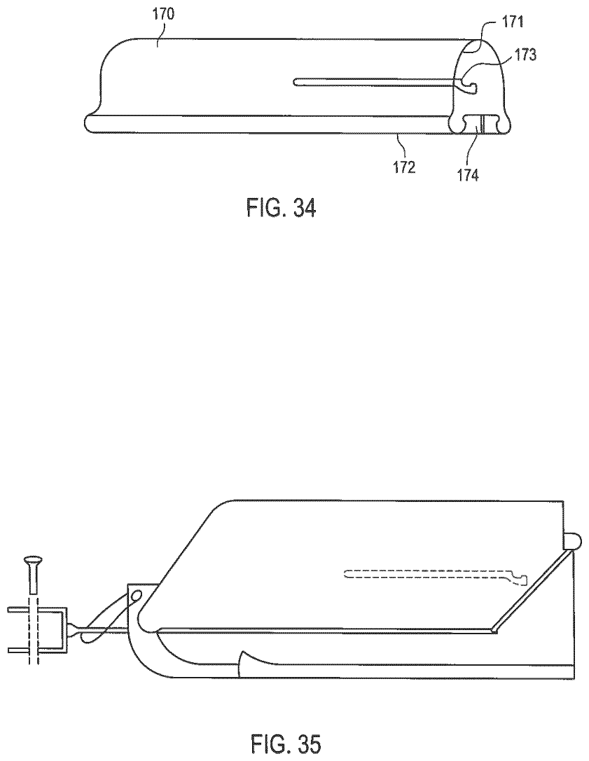

FIGS. 34 and 35 illustrate an alternative mating system using rails. With reference to FIG. 34, hood 170 includes an inner surface 171 and a lower perimeter 172. On the inside surface 171, one or more rails 173 may be formed on each side of the hood. In operation, each rail 173 couples to a mating rail on the sides of the transport body as shown in FIG. 35. In this manner, the hood is coupled with and secured over the body of the transport.

The rails may function similar to sliding drawers and slide back and forth; they may fit into mutual mating grooves and slide against each other; the rail on the hood may hang on the rail attached to the body of the transport (so that it can be lifted on or off); the rails on the hood and transport may latch onto one another using a projection of one resting in a depression of the other; or they may couple in any known manner that permit removal of the hood by disengaging the rails. The rails on the transport body may be placed on the rim 112 or the gunnel. Alternatively, they may be placed on the sides 104 of the body below the rim or gunnel. This latter alternative creates an overhang that seals the inside of the transport from rain or water. FIG. 35 shows such an embodiment. The hood as shown in FIG. 34 is secured onto the transport body using the rail system. In FIG. 35, the transport rails are attached to the body below the rim such that the hood covers the rim. The lower perimeter 172 of the hood seals against the outer body of the transport. The hood may be equipped with contour features 174 which improve sealing along the seam between the hood and the transport.

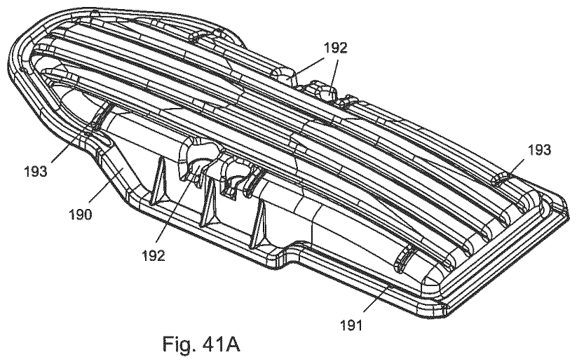

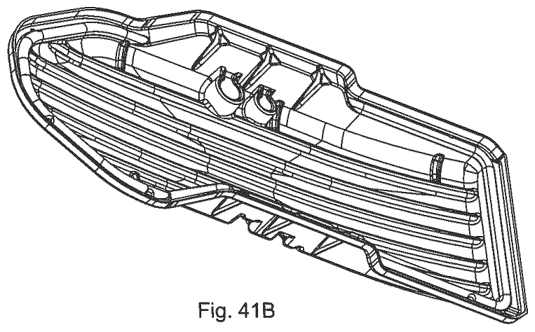

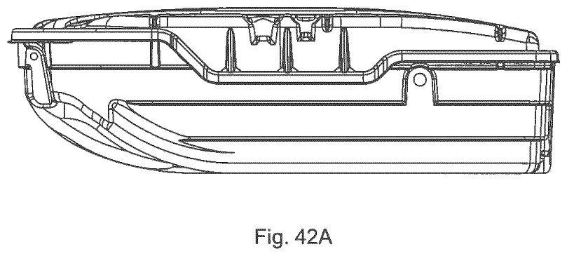

FIGS. 41A-B depict one embodiment of a hood which is adapted for the body as shown in FIG. 36A. Although the features shown therein can be incorporated into any embodiment of the present transport. FIG. 41A depicts the hood from the outside and 41B depicts its inside surface. The hood cover includes a rim 190, cup holders 192, and bungie contours 193 formed into the outside of the hood. In FIG. 41A, four cup holders and six bungie contours are shown. The hood includes rim 190 around its perimeter which mates with the rim or gunnel on the body to close off the body. FIG. 42A show a side view of the body with the hood cover. FIGS. 42B and 42C are front and rear views respectively. FIG. 43 shows a perspective of the same transport with a harness attached.

One simple mechanism for securing the hood cover to the body of the transport includes installing an eye pin 200 (or another type of hardware with a flat, enlarged head portion) on the gunnel or rim of the body. Corresponding slots 191 are then formed on the rim of the hood cover (FIG. 41A), creating openings for the eye pics. When the eye pin is turned parallel to the slot, the cover may be placed on the body with the rim of the cover coupling with the gunnel of the body. The eye pins protrudes through the slots around the hood cover. By turning the eye pin 90 degrees, the enlarged head becomes perpendicular to the opening of the slot and secures the hood cover on the body. The height of the pin may be selected to choose a snug latch when turned. Bungies or other attachment mechanisms can be connected to the eye of the eye pin and held in place in the bungie contours providing additional storage on the transport.

FIG. 43 illustrates the transport body with the rims of the body and hood cover coupled together with the eye pins as described above. FIG. 43 additionally shows other hardware as installed including a handle, and attachment hardware. FIG. 44 shows the body of the transport with the harness coupled thereto.

In the embodiment of FIG. 44, as described above, the harness is attached to the body of the transport using pins through round holes in the harness which align with the connection points on the body (similar to mechanism 121 in FIG. 1A). In an alternative embodiment, these holes may be oval or oblong, forming a slot. When the attachment pin is within the slot, it may move to and fro, allowing relative movement between the harness and the body. This relative movement may have several advantages. For example, when towing on rough terrain, this relative movement can reduce the stress on the body of the transport, especially at the attachment points. Additionally, the relative movement between the harness and the body may allow the body to be pulled forward to position such that the lip on the bow can rest on the horizontal member of the harness. The body may also be pulled back to allow the lip to be dismounted from the horizontal member, butted up against it as shown in FIG. 43, or spaced from it. This to and fro movement assists in mounting and unmounting of the transport from the harness. This relative movement is also advantageous when raising the body on its end, for example as shown in FIG. 14, by facilitating the rotation of the body about the point of pivot. To stop the relative movement, known mechanisms may be used. One simple mechanism includes attaching the handle on the bow to the horizontal member on the harness using a D-ring. Alternatively, stoppers may be used in the slots.

The transport of the present disclosure may be utilized for these various uses in the upright configuration as descripted. It may also be used in these ways while remaining horizontal. In the horizontal configuration, top side 111 will not function as a seat, but the top surface of portion 107 (FIG. 2) will. The hood may be used to provide a waterproof cover during transport to keep out rain, snow, mud, or dirt. When removed, it may provide an additional receptacle which may be towed along, or it may be used as a receptacle to hold gear when stopped. For example, when the combination of the hood cover and body are used as depicted in FIG. 43, the transport of the present invention becomes a four-season transport. And because the combination of the cover and body seals against entry of mud and water, the transport may be towed behind a motorcycles-which is not practical with soft-top trailers due to the mud and debris resulting from the motorcycle.

Moreover, the present transport can many use modalities: the hood cover may be used as a roof rack or a towing sled by itself; the transport body or sled may be used with or without the hood cover as a sled or other transport; the transport body or sled may be used in combination with a harness to be towed on its own skis or wheels, for example as shown in FIGS. 1A; the sled may be used with the harness having its own wheels such as that shown in FIG. 38B; and the harness can itself be used as a trailer. These benefits and flexibilities are achieved with the features and aspects disclosed herein. Again, FIG. 43 shows the transport with the hood cover sealing its top and one type of harness mounted for connection to a tow hitch. The hardware secures the harness and hood cover to the body. The bungees stretched across the top allow for additional items to be secured to the hood cover.

The present teachings can be implemented in several different ways as taught by the details discussed in the specification. The features of one embodiment can be combined with features of other embodiments, some of which are discussed by way of examples above. Modifications and variations will be apparent to the person of ordinary skill in the art in view of the present teachings without departing from the scope and spirit of these teachings. Such modifications or variations are contemplated by the applicant and the teachings herein are intended as explanations to illuminate the scope of such modification and not as limiting examples. The particulars set forth in the specific embodiments described herein are not intended to limit the breadth and scope of the claims.

1. A multifunctional transport comprising:
a transport body;
a harness;
a hood cover;
where in the transport body has an end portion configured to enable the transport to be erected on end; wherein the transport body is sized so as to be capable of being used as a shelter when erected on end;
wherein the hood cover removably couples to the transport body;
wherein the harness has an end which couples to the transport body and another end which is configured to be coupled to a vehicle for towing.

2. The multifunctional transport of claim 1 wherein the harness includes wheels.

3. The multifunctional transport of claim 1 wherein the harness does not include wheels.

4. The multifunctional transport of claim 1 wherein the transport body includes ribs.

5. The multifunctional transport of claim 1 wherein the transport body includes a transport modality comprising at least one of a ski, skate, skid, rib, and wheel.

6. The multifunctional transport of claim 5 wherein the transport modality couples to the transport body removably at an attachment point.

7. The multifunctional transport of claim 1 wherein the transport body has an end portion, wherein said end portion is configured such that the transport body can be raised on said end.

8. The multifunctional transport of claim 5 wherein the transport body has an end portion; wherein said end portion is configured such that the transport body can be raised on said end; and wherein the transport body rotates about the attachment point when raised on end.

9. The multifunctional transport of claim 1 wherein the transport body includes ribs and skis.

10. The multifunctional transport of claim 1 wherein the body comprises high molecular weight polymer.

11. The multifunctional transport of claim 1 wherein the body is fabricated from high molecular weight polymer.

12. The multifunctional transport of claim 1 wherein the body is comprised of Delron or Delrin.

13. The multifunctional transport of claim 1 wherein the transport body includes a bow and wherein the bow includes a rib.

14. The multifunctional transport of claim 1 wherein the transport body includes a bow and wherein the bow includes a ram.

15. The multifunctional transport of claim 1 wherein the harness is coupled to the transport on two sides of the body using a cross bar.

16. The multifunctional transport of claim 15 wherein the cross bar additionally couples a wheel to the transport body.

17. The multifunctional transport of claim 15 wherein the cross bar additionally couples a ski, ski, or skate to the transport body.

18. The multifunctional transport of claim 1 wherein the hood cover has a perimeter and the transport body has an upper periphery; wherein said perimeter covers said upper periphery to create a generally water impervious seal.
